(19) United States
(12) Patent Application Publication
(10) Pub. No.: US 2012/0015121 A1
(43) Pub. Date: Jan. 19, 2012

(54) METHOD OF FORMING A PIGMENT LAYER AND A FOAM LAYER ON A SUBSTRATE AND A CONTAINER TREATED BY THE SAME

(76) Inventors: Sheng-Su CHANG, Taichung (TW); Ching-Wen Chang, Taichung (TW)

(21) Appl. No.: 12/837,727

(22) Filed: Jul. 16, 2010

(51) Int. Cl. B32B 1/00; B32B 9/00; B32B 5/20; B05D 1/36; B05D 5/00

(52) U.S. Cl. 428/36.5; 427/265; 427/261

(57) ABSTRACT

The method of forming a pigment layer and a foam layer on a substrate includes steps of material preparation, material coating, pigment coating and foaming. A coating material layer is coated on the substrate, and then a pigment layer is coated on the substrate before the coating material layer is foamed. Thus the pigment can be coated on the substrate more easily and more accurately.

### BACKGROUND OF THE INVENTION

1. Field of the Invention

The present invention relates to a method of forming a pigment layer and a foam layer on a substrate and a container treated by the method.

2. Description of the Prior Art

There are some containers printed with patterns to show the contents and/or marketing information. There are also some containers coated with foam layer to mitigate the heat conductance, as disclosed in Taiwan patent applications whose app. no. are 94143974 and 96102426. Both the Taiwan patent applications disclose that pigment can be added into the coating material, thus the foam layer becomes colorful when the coating material is foamed. They also disclose that the foam layer can be printed to have patterns. However, printing on a non-smooth surface makes the patterns vague.

U.S. Pat. No. 5,952,068 also discloses a container with a foam layer(s), and '068 also taught that the coating material can be mixed with a pigment. As shown in FIG. 5 of '068, a label area is formed on the container, yet '068 remains silence how to make the patterns accurately print on a non-smooth surface, especially one with expandable layer.

Please refer to FIG. 6 and FIG. 7. As taught in the disclosure hereinabove, the pigment is printed on the foam layer 3 and on the outer surface of the container. However, there is a height drop between the foam layer 3 and the outer surface, which makes it hard to print, especially on the side surface 5 of the foam layer 3. Most of the time, such side surface 5 cannot be successfully fully printed with pigments. Further refer to FIG. 8. If one were to print patterns on the gap between the foam layers 3, it would be another hard task because the foam layers 3 would block the printing nozzle. Thus the patterns could not be printed accurately.

The present invention is, therefore, arisen to obviate or at least mitigate the above mentioned disadvantages.

### SUMMARY OF THE INVENTION

The main object of the present invention is to provide a method to accurately form a foam layer and a pigment layer on a substrate.

To achieve the above and other objects, the method of the present invention includes the following steps:

material preparation: preparing a coating material by mixing and blending a binder and a thermo-expandable powder consisting of a plurality of thermo-expandable microcapsules, each thermo-expandable microcapsule consisting of a thermoplastic polymer shell and a low-boiling-point solvent wrapped by the thermoplastic polymer shell;

coating material coating: coating the coating material on a part of an outer surface of the substrate to form a coated layer, at least one non-coated portion being formed on the substrate, the non-coated portion being defined by the coated layer;

pigment coating: coating a pigment on at least a part of the non-coated portion to form a pigment layer; and

foaming: heating the coated substrate till the coated layer foaming so that the coated layer becomes a foam layer, the non-coated portion being thus defined by the foam layer instead.

To achieve the above and other objects, another method of the present invention includes the following steps:

material preparation: preparing a coating material by mixing and blending a binder and a thermo-expandable powder consisting of a plurality of thermo-expandable microcapsules, each thermo-expandable microcapsule consisting of a thermoplastic polymer shell and a low-boiling-point solvent wrapped by the thermoplastic polymer shell;

pigment coating: coating a pigment on at least a part of substrate to form a pigment layer;

coating material coating: coating the coating material on a part of an outer surface of the pigment-coated substrate to form a coated layer, at least one non-coated portion being formed on the substrate, the non-coated portion being defined by the coated layer, at least a part of the pigment layer being located in the non-coated portion; and

foaming: heating the coated substrate till the coated layer foaming so that the coated layer becomes a foam layer, the non-coated portion being thus defined by the foam layer instead.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a flow chart of a method of the present invention;

FIG. 1A is a flow chart of another method of the present invention;

FIG. 1B is a profile showing a substrate coated with a pigment layer and then a coated layer of the present invention;

FIG. 1C is a profile showing a substrate coated with a pigment layer and then a coated layer, in which the coated layer is formed to become a foam layer of the present invention.

FIG. 2A is a profile showing a substrate coated with a coated layer and then a pigment layer of the present invention;

FIG. 2B is a profile showing a substrate coated with a coated layer and then a pigment layer of the present invention, in which the coated layer is formed to become a foam layer;

FIG. 3A is a profile showing another substrate coated with a coated layer and then a pigment layer of the present invention;

FIG. 3B is a profile showing another substrate coated with a coated layer and then a pigment layer of the present invention, in which the coated layer is formed to become a foam layer;

FIG. 4A is a profile showing yet another substrate coated with a coated layer and then a pigment layer of the present invention;

FIG. 4B is a profile showing yet another substrate coated with a coated layer and then a pigment layer of the present invention, in which the coated layer is formed to become a foam layer;

FIG. 5 is a perspective drawing showing a container of the present invention;

FIG. 6 is a profile showing a substrate coated with a foam layer and a pigment layer of the prior art;

FIG. 7 is a profile showing another substrate coated with a foam layer and a pigment layer of the prior art;

FIG. 8 is a profile showing yet another substrate coated with a foam layer and a pigment layer of the prior art.

### DETAILED DESCRIPTION OF THE PREFERRED EMBODIMENTS

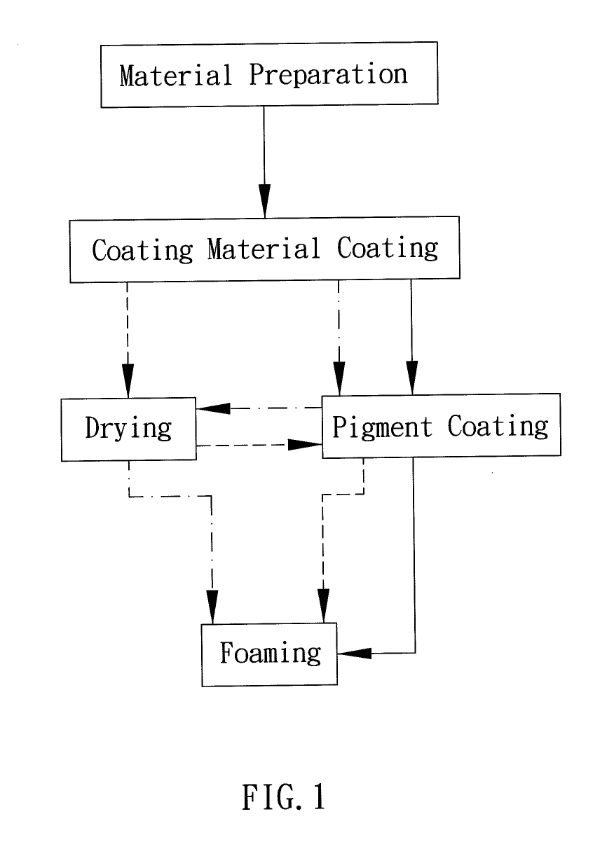

Please refer to FIG. 1. A method of forming a pigment layer and a foam layer on a substrate includes the following steps:

Material Preparation: preparing a coating material by mixing and blending a binder and a thermo-expandable powder consisting of a plurality of thermo-expandable microcapsules, each of which consists of a thermoplastic polymer shell and a low-boiling-point solvent wrapped by the thermoplastic polymer shell. The binder is preferably selected from a group consisting of polyvinyl acetate resin, ethylene vinyl acetate resin, polyurethane resin and a mixture thereof, and the binder can be either water soluble resin or oleoresin.

Coating Material Coating: coating the coating material on a part of an outer surface of the substrate to form a coated layer, and at least one non-coated portion being formed on the substrate, in which the non-coated portion is defined by the coated layer. The substrate can be paper, plastic, Styrofoam or the like, and the substrate is adapted to be manufactured into a container such as a cup, a bowl, a disc or the like. For example, the substrate can be a paper reel and can be subsequently cut and assembled into a paper cup. Further, the coating material can be coated on the substrate in the manner of rolling, spraying, dipping, printing, air knife, extruding, scraper applying or the like.

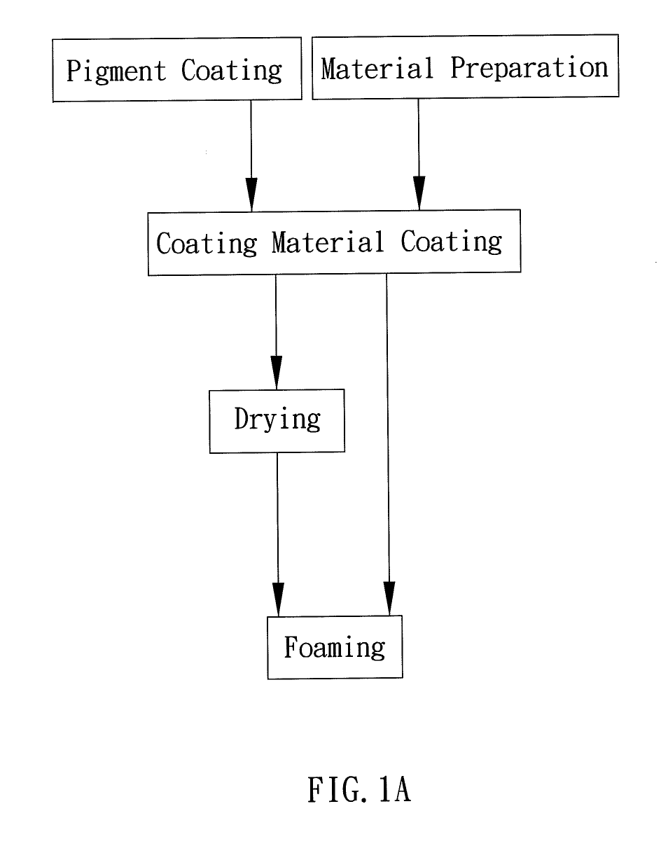

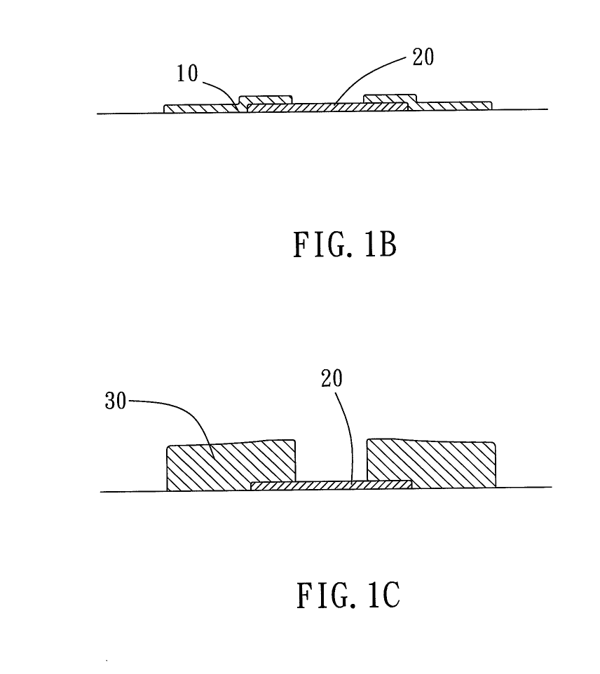

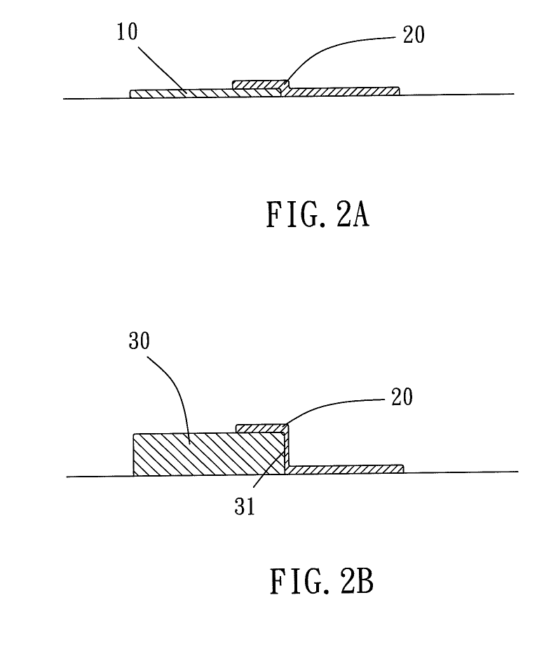

Pigment Coating: coating a pigment on at least a part of the non-coated portion to form a pigment layer, and preferably the coated layer is also coated to have a pigment layer itself. For example, FIG. 2A and FIG. 3A show a continuous pigment layer 20 is coated on the coated layer(s) 10 as well as the non-coated portion, while FIG. 4A shows the pigment layer 20 are coated on the narrow non-coated portion sandwiched between two adjacent coated layers 10. Due to the unobvious height drop between the coated layer 10 and the substrate, the pigment layer can thus be easily and precisely coated on the non-coated portion and the coated layer.

Foaming: heating the coated substrate till the coated layer foams so that he coated layer becomes a foam layer. The thickness of the foam layer is at least twice that of the coated layer. Please refer to FIG. 2B and FIG. 3B. As the coated layer(s) expands and becomes the foam layer 30, the pigment layer 20 on the coated layer(s) is thus propped up, yet the side surface(s) 31 of the foam layer 30 is still covered by the pigment layer. Thus the pattern of the pigment layer can still be continuous. Further refer to FIG. 4B. As the coated layers expand, the pigment layer 20 can still locate at the narrow non-coated portion.

A drying step can be further included in the present method, in which the drying step is to dry the coated layer at a temperature lower than a foaming point, where the foaming starts, of the thermo-expandable microcapsules so that the coated layer can adhere to the substrate and becomes a non-sticky coated layer. As such, the coated substrate can be stored for later use. More specifically, the drying step is either between the pigment coating step and the foaming step or between the coating material coating step and the pigment coating step.

Because the pigment layer is coated on the substrate before the coated layer expands, the pigment layer can be more precisely coated on the substrate, and the side surface of the foam layer can still be covered by the pigment layer.

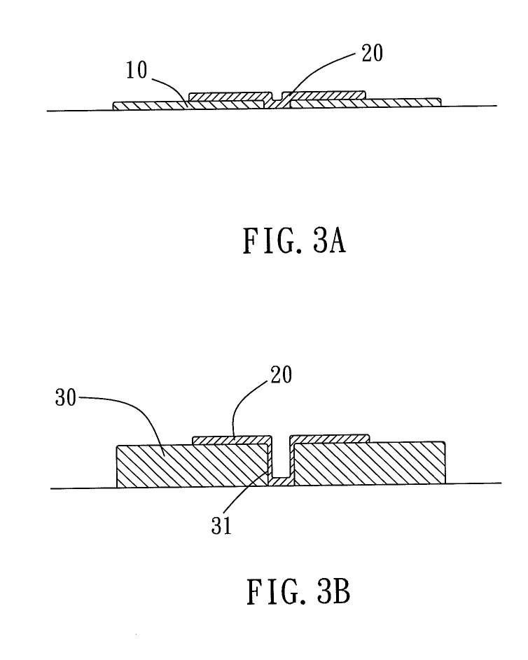

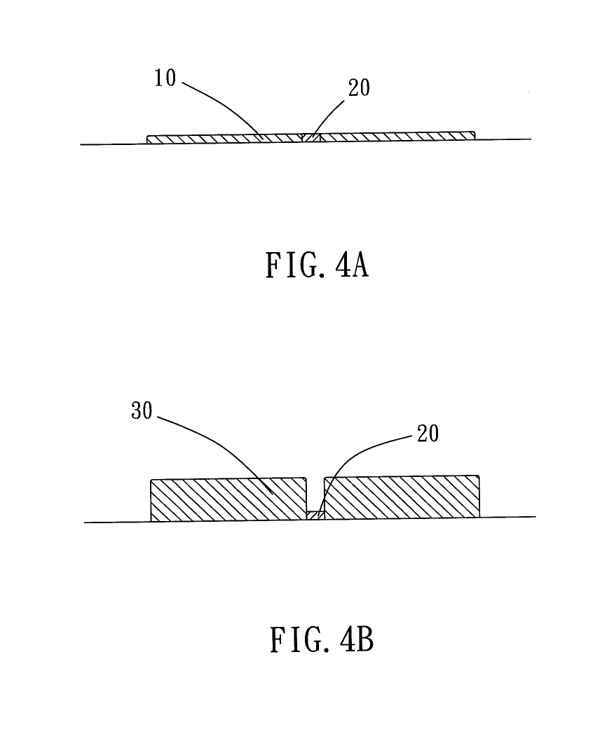

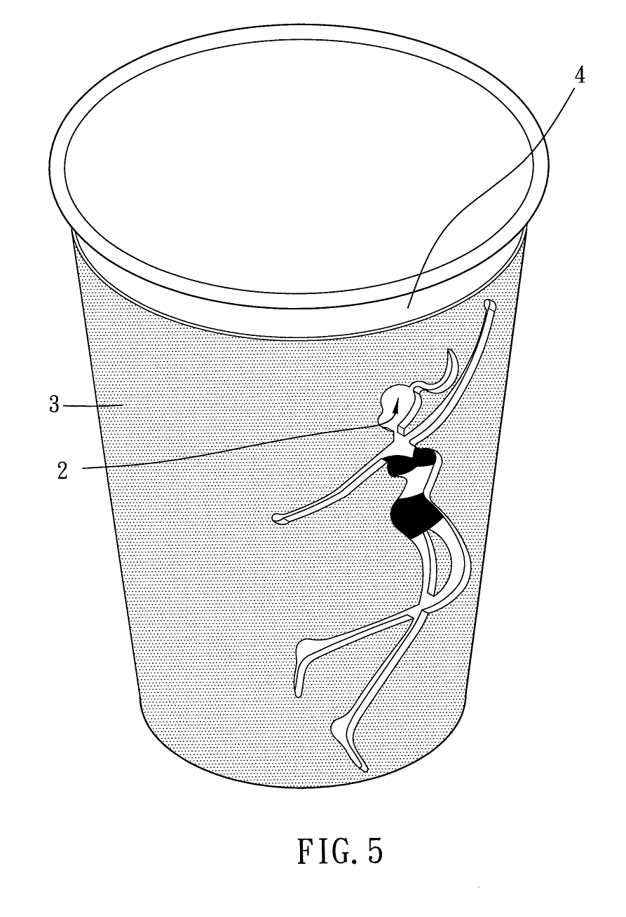

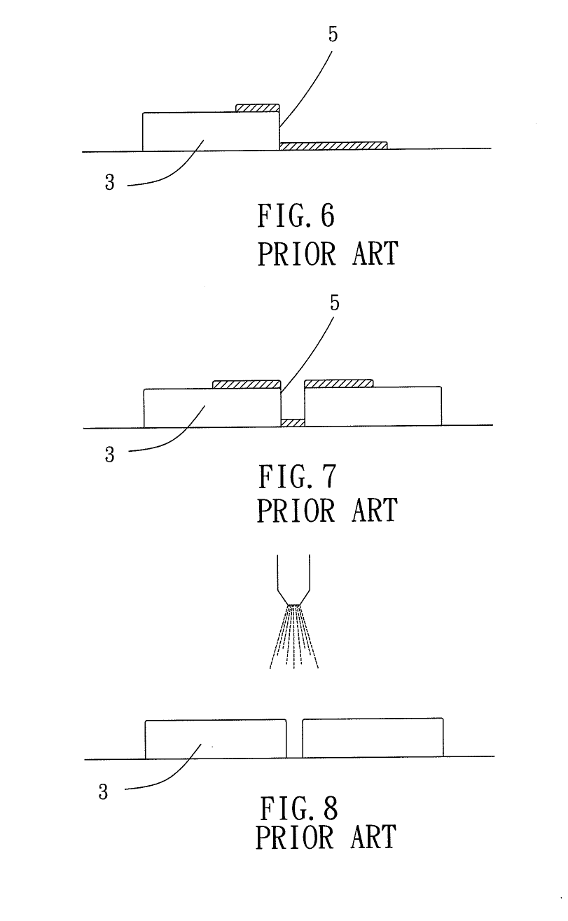

As shown in FIG. 5, the cup has a body 4 and a bottom disposed on a lower end of the body 4. The body 4 is made by annularly bending fixing the substrate, thus a foam layer 20 with a non-coated portion 2 is formed on the outer surface of the body 4. The pattern in the non-coated portion 2 is thus more highlighted and looks more stereo.

The present invention further provides a method, as shown in FIG. 1A, similar to the prior one, in which the method includes the following steps:

Material Preparation: preparing a coating material by mixing and blending a binder and a thermo-expandable powder consisting of a plurality of thermo-expandable microcapsules.

Pigment Coating: coating a pigment on at least a part of substrate to form a pigment layer;

Coating Material Coating: Coating the coating material on a part of an outer surface of the pigment-coated substrate to form a coated layer. At least one non-coated portion is formed on the substrate, and the non-coated portion is defined by the coated layer. At least a part of the pigment layer is located in the non-coated portion; and

Foaming: heating the coated substrate till the coated layer foams so that the coated layer becomes a foam layer. The non-coated portion is thus defined by the foam layer instead.

As shown in FIG. 1B, the coating material is coated on the substrate to form two coated layers 10 after the substrate is coated with a pigment layer 20. When the coated layers 10 are foamed to become the foam layers 30 as shown in FIG. 1C, the pigment layer 20 remains in a good shape. Preferably the foam layer is transparent or semi-transparent so that the user can see the pattern overlapped by the foam layer.

What is claimed is:

1. A method of forming a pigment layer and a foam layer on a substrate, comprising the following steps:
material preparation: preparing a coating material by mixing and blending a binder and a thermo-expandable powder consisting of a plurality of thermo-expandable microcapsules, each thermo-expandable microcapsule consisting of a thermoplastic polymer shell and a low-boiling-point solvent wrapped by the thermoplastic polymer shell;
coating material coating: coating the coating material on a part of an outer surface of the substrate to form a coated layer, at least one non-coated portion being formed on the substrate, the non-coated portion being defined by the coated layer;
pigment coating: coating a pigment on at least a part of the non-coated portion to form a pigment layer; and
foaming: heating the coated substrate till the coated layer foaming so that the coated layer becomes a foam layer, the non-coated portion being thus defined by the foam layer instead.

2. The method of claim 1, wherein in the pigment coating step, the pigment is also coated on the coated layer and forms a pigment layer, the pigment layer on the coated layer and the pigment layer on the non-coated portion are continuous.

3. The method of claim 1, further comprising a step between the coating material coating step and the foaming step:
drying: drying the coated layer at a temperature lower than a foaming point of the thermo-expandable microcapsules so that the coated layer adhere to the substrate and becomes a non-sticky coated layer.

4. The method of claim 3, wherein in the pigment coating step, the pigment is also coated on the coated layer and forms a pigment layer, the pigment layer on the coated layer and the pigment layer on the non-coated portion are continuous.

5. The method of claim 3, wherein the drying step is between the pigment coating step and the foaming step.

6. The method of claim 3, wherein the drying step is between the coating material coating step and the pigment coating step.

7. The method of claim 1, wherein the binder is selected from a group consisting of polyvinyl acetate resin, ethylene vinyl acetate resin, polyurethane resin and a mixture thereof.

8. A container, treated by the method of claim 1, wherein the container includes a body and a bottom disposed on a lower end of the body, the substrate is annularly bent to form the body.

9. A method of forming a pigment layer and a foam layer on a substrate, comprising the following steps:
material preparation: preparing a coating material by mixing and blending a binder and a thermo-expandable powder consisting of a plurality of thermo-expandable microcapsules, each thermo-expandable microcapsule consisting of a thermoplastic polymer shell and a low-boiling-point solvent wrapped by the thermoplastic polymer shell;
pigment coating: coating a pigment on at least a part of substrate to form a pigment layer;
coating material coating: coating the coating material on a part of an outer surface of the pigment-coated substrate to form a coated layer, at least one non-coated portion being formed on the substrate, the non-coated portion being defined by the coated layer, at least a part of the pigment layer being located in the non-coated portion; and
foaming: heating the coated substrate till the coated layer foaming so that the coated layer becomes a foam layer, the non-coated portion being thus defined by the foam layer instead.

10. The method of claim 9, further comprising a step between the coating material coating step and the foaming step:
drying: drying the coated layer at a temperature lower than a foaming point of the thermo-expandable microcapsules so that the coated layer adhere to the substrate and becomes a non-sticky coated layer.

11. The method of claim 9, wherein the binder is selected from a group consisting of polyvinyl acetate resin, ethylene vinyl acetate resin, polyurethane resin and a mixture thereof.

12. The method of claim 9, wherein the foam layer is transparent or semi-transparent.

13. A container, treated by the method of claim 9, wherein the container includes a body and a bottom disposed on a lower end of the body, the substrate is annularly bent to form the body.
